(19) United States
(12) Patent Application Publication
(10) Pub. No.: US 2022/0377043 A1
(43) Pub. Date: Nov. 24, 2022

(54) ENABLING NAT FOR USER PLANE TRAFFIC

(71) Applicant: Telefonaktiebolaget LM Ericsson (publ), Stockholm (SE)

(72) Inventors: Yong Yang, Kållered (SE); Ting Zhu, Shanghai (CN); Veronica Sanchez Vega, Madrid (ES); Miguel Angel Muñoz De La Torre Alonso, Madrid (ES); Javier Muñoz Kirschberg, Madrid (ES)

(21) Appl. No.: 17/626,221

(22) PCT Filed: Jul. 14, 2020
(86) PCT No.: PCT/EP2020/069874

§ 371 Date: Jan. 11, 2022

(30) Foreign Application Priority Data
Jul. 16, 2019 (CN) PCT/CN2019/096161

(51) Int. Cl. H04L 61/2514; H04L 47/35; H04L 12/14

(52) U.S. Cl. CPC H04L 61/2514; H04L 47/35; H04L 12/1407

(57) ABSTRACT

Systems and methods for providing Network Address Translation (NAT) are provided. In some embodiments, a method of operating a function entity configured to support NAT includes enabling a Control Plane (CP) function to instruct a User Plane (UP) function to apply a NAT function for at least one specific service data flow. In this way, one or more benefits result such as: introducing a mechanism allowing CP function to instruct UP function to perform NAT function for one or more service data flow(s); when CP and UP function are separated, using NAT function can protect a private network from potential unlawful incursion, and delaying NAT IP address and port allocation and withdrawal at the service initiation and termination can save the public IP address space. Also, one or more improvements such as allowing the network operator to support NAT policies in the context of 4G/5G networks supporting CUPS are disclosed.

### TECHNICAL FIELD

The present disclosure relates to Network Address translation (NAT) in communications networks.

### BACKGROUND

Network Address Translation (NAT) is a method of remapping one Internet Protocol (IP) address space into another IP address space by modifying network address information in the IP header of packets while they are in transit across a traffic routing device. Network Address and Port Translation (NAPT) also includes modifying the source port in the transport header. The NAT and the NAPT operate in a similar or corresponding manner.

NAT provides a translation technology which allows multiple end customers to use common and overlapping private IP address ranges internally. Any number of end customers can use the same private IP address ranges. To route to external Internet IP addresses, NAT translates the private IP addresses to public IP addresses, e.g. NAT44 which translates from private to public IPv4 address needed to cope with IPv4 address depletion.

With the advent of enterprise and home solutions and migration to IPv6, service providers have deployed Carrier Grade NAT (CGNAT) which provides additional NAT schemes such as NAT64 or NAT444.

Since NAT can break some upper application protocols which include the IP address value in their signaling (e.g. File Transfer Protocol (FTP), Session Initiation Protocol (SIP)), CGNAT needs to support Application Level Gateway (ALG) which modifies those protocols. CGNAT servers are usually deployed in the service provider service Local Area Network (LAN). Improved systems and methods for providing network address translation are needed.

### SUMMARY

Systems and methods for providing Network Address Translation (NAT) are provided. In some embodiments, a method of operating a function entity configured to support NAT includes enabling a Control Plane (CP) function to instruct a User Plane (UP) function to apply a NAT function for at least one specific service data flow. In this way, one or more benefits result such as: introducing a mechanism to allow CP function to instruct UP function to perform NAT function for one or more service data flow(s), when CP and UP function are separated; using NAT function can protect a private network from potential unlawful incursion; and delaying NAT Internet Protocol (IP) address and port allocation and withdraw at the service initiation and termination can save the public IP address space.

Also, embodiments of the current disclosure might result in one or more improvements such as allowing the network operator to support NAT policies in the context of 4G/5G networks supporting Control and User Plane Separation of EPC nodes (CUPS). This is of value, e.g., for Access Traffic Steering, Switching and Splitting (ATSSS) functionality where Session Management Functions (SMFs) can program the translation from a link specific address to the public IP address assigned to the Multi-access Packet Data Unit (PDU) session.

In some embodiments, the at least one specific service data flow belongs to a given Packet Flow Control Protocol (PFCP) session. In some embodiments, enabling the CP function to instruct the UP function comprises using a new UP function feature, which in some embodiments is called “Support of Network Address Translation in UP function”, NATU.

In some embodiments, enabling the CP function to instruct the UP function comprises using a new feature bit can be defined in a “UP function features” Information Element (IE). In some embodiments, enabling the CP function to instruct the UP function comprises using a new NAT IE in the Forwarding Parameters IE in the Forwarding Action Rule (FAR). In some embodiments, enabling the CP function to instruct the UP function involves enhancements in at least one of: the 3GPP N4 interface, the Npcf interface, and the Nudr interface (service-based interfaces).

In some embodiments, enabling the CP function to instruct the UP function comprises delaying NAT IP address and port allocation at the service initiation. In some embodiments, enabling the CP function to instruct the UP function comprises delaying NAT IP address and port withdrawal at the service termination.

In some embodiments, enabling the CP function to instruct the UP function comprises enabling NAT granularity of at least one of: on a per global basis; on a per subscriber basis; on a per Data Network Name (DNN) basis; per PDU session basis; per data flow basis and on a per application basis.

In some embodiments, the method also includes providing subscriber awareness and upper application protocol inspection to provide subscriber aware NAT logs or application aware NATing.

In some embodiments, the function entity operates in a Fifth Generation Core (5GC) network. In some embodiments, the function entity is one or more of: a User Plane Function (UPF); a Session Management Function (SMF); a Policy Control Function (PCF); and a combination of any of these.

In some embodiments, the function entity operates in an Evolved Packet Core (EPC) network. In some embodiments, the function entity is one or more of: a Packet Data Network (PDN) Gateway (PGW) CP function (PGW-C) node; a PGW UP function (PGW-U) node; and a Policy Control Rules Function (PCRF) node.

### BRIEF DESCRIPTION OF THE DRAWINGS

The accompanying drawing figures incorporated in and forming a part of this specification illustrate several aspects of the disclosure, and together with the description serve to explain the principles of the disclosure.

FIG. 1 illustrates one example of a cellular communications network according to some embodiments of the present disclosure;

FIG. 2 illustrates a wireless communication system represented as a 5G network architecture composed of core Network Functions (NFs), where interaction between any two NFs is represented by a point-to-point reference point/interface;

FIG. 3 illustrates a 5G network architecture using service-based interfaces between the NFs in the control plane, instead of the point-to-point reference points/interfaces used in the 5G network architecture of FIG. 2;

FIG. 4 illustrates an example where the use of multiple Virtual Private Networks (VPNs) can cause ambiguity;

FIG. 5 illustrates an example where the Network Address Translation (NAT) Internet Protocol (IP) is allocated prior to being needed;

FIG. 6 illustrates examples without and with NAT IP address;

FIG. 7 illustrates an example of NAT IP allocation on service access;

FIGS. 8A and 8B illustrate an exemplary embodiment for Packet Flow Control Protocol (PFCP) interaction;

FIG. 9 illustrates an example of the Evolved Packet Core (EPC) core network;

FIG. 10 illustrates an example reflecting Control Plane and User Plane separation;

FIG. 11 illustrates an example of a 4G and 5G interworking architecture;

FIG. 12 illustrates the example of NAT policies configured on a per subscriber basis and when NAT IP address pool is handled in SMF;

FIG. 13 is a schematic block diagram of a radio access node according to some embodiments of the present disclosure;

FIG. 14 is a schematic block diagram that illustrates a virtualized embodiment of the radio access node of FIG. 13 according to some embodiments of the present disclosure;

FIG. 15 is a schematic block diagram of the radio access node of FIG. 13 according to some other embodiments of the present disclosure;

FIG. 16 is a schematic block diagram of a User Equipment device (UE) according to some embodiments of the present disclosure;

FIG. 17 is a schematic block diagram of the UE of FIG. 16 according to some other embodiments of the present disclosure.

### DETAILED DESCRIPTION

The embodiments set forth below represent information to enable those skilled in the art to practice the embodiments and illustrate the best mode of practicing the embodiments. Upon reading the following description in light of the accompanying drawing figures, those skilled in the art will understand the concepts of the disclosure and will recognize applications of these concepts not particularly addressed herein. It should be understood that these concepts and applications fall within the scope of the disclosure.

Radio Node: As used herein, a “radio node” is either a radio access node or a wireless device.

Radio Access Node: As used herein, a “radio access node” or “radio network node” is any node in a radio access network of a cellular communications network that operates to wirelessly transmit and/or receive signals. Some examples of a radio access node include, but are not limited to, a base station (e.g., a New Radio (NR) base station (gNB) in a Third Generation Partnership Project (3GPP) Fifth Generation (5G) NR network or an enhanced or evolved Node B (eNB) in a 3GPP Long Term Evolution (LTE) network), a high-power or macro base station, a low-power base station (e.g., a micro base station, a pico base station, a home eNB, or the like), and a relay node.

Core Network Node: As used herein, a “core network node” is any type of node in a core network or any node that implements a core network function. Some examples of a core network node include, e.g., a Mobility Management Entity (MME), a Packet Data Network Gateway (PGW), a Service Capability Exposure Function (SCEF), a Home Subscriber Server (HSS), or the like. Some other examples of a core network node include a node implementing a Access and Mobility Function (AMF), a User Plane Function (UPF), a Session Management Function (SMF), an Authentication Server Function (AUSF), a Network Slice Selection Function (NSSF), a Network Exposure Function (NEF), a Network Function (NF) Repository Function (NRF), a Policy Control Function (PCF), a Unified Data Management (UDM), or the like.

Wireless Device: As used herein, a “wireless device” is any type of device that has access to (i.e., is served by) a cellular communications network by wirelessly transmitting and/or receiving signals to a radio access node(s). Some examples of a wireless device include, but are not limited to, a User Equipment device (UE) in a 3GPP network and a Machine Type Communication (MTC) device.

Network Node: As used herein, a “network node” is any node that is either part of the radio access network or the core network of a cellular communications network/system.

Note that the description given herein focuses on a 3GPP cellular communications system and, as such, 3GPP terminology or terminology similar to 3GPP terminology is oftentimes used. However, the concepts disclosed herein are not limited to a 3GPP system.

Note that, in the description herein, reference may be made to the term “cell”; however, particularly with respect to 5G NR concepts, beams may be used instead of cells and, as such, it is important to note that the concepts described herein are equally applicable to both cells and beams.

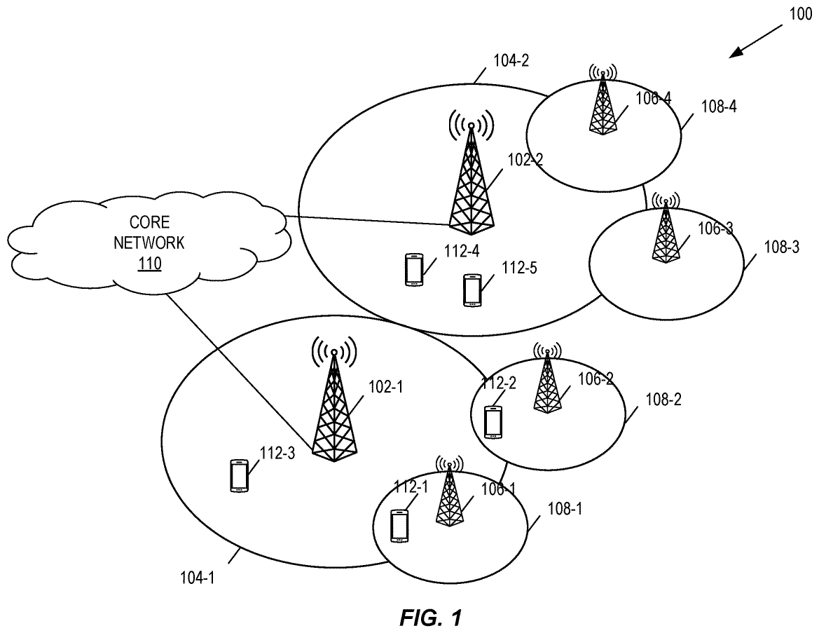

### FIG. 1

FIG. 1 illustrates one example of a cellular communications system 100 in which embodiments of the present disclosure may be implemented. In the embodiments described herein, the cellular communications system 100 is a 5G system (5GS) including a NR Radio Access Network (RAN) or an Evolved Packet System (EPS) including a LTE RAN. In this example, the RAN includes base stations 102-1 and 102-2, which in LTE are referred to as eNBs and in 5G NR are referred to as gNBs, controlling corresponding (macro) cells 104-1 and 104-2. The base stations 102-1 and 102-2 are generally referred to herein collectively as base stations 102 and individually as base station 102. Likewise, the (macro) cells 104-1 and 104-2 are generally referred to herein collectively as (macro) cells 104 and individually as (macro) cell 104. The RAN may also include a number of low power nodes 106-1 through 106-4 controlling corresponding small cells 108-1 through 108-4. The low power nodes 106-1 through 106-4 can be small base stations (such as pico or femto base stations) or Remote Radio Heads (RRHs), or the like. Notably, while not illustrated, one or more of the small cells 108-1 through 108-4 may alternatively be provided by the base stations 102. The low power nodes 106-1 through 106-4 are generally referred to herein collectively as low power nodes 106 and individually as low power node 106. Likewise, the small cells 108-1 through 108-4 are generally referred to herein collectively as small cells 108 and individually as small cell 108. The cellular communications system 100 also includes a core network 110, which in the 5GS is referred to as the 5G core (5GC). The base stations 102 (and optionally the low power nodes 106) are connected to the core network 110.

The base stations 102 and the low power nodes 106 provide service to wireless devices 112-1 through 112-5 in the corresponding cells 104 and 108. The wireless devices 112-1 through 112-5 are generally referred to herein collectively as wireless devices 112 and individually as wireless device 112. The wireless devices 112 are also sometimes referred to herein as UEs.

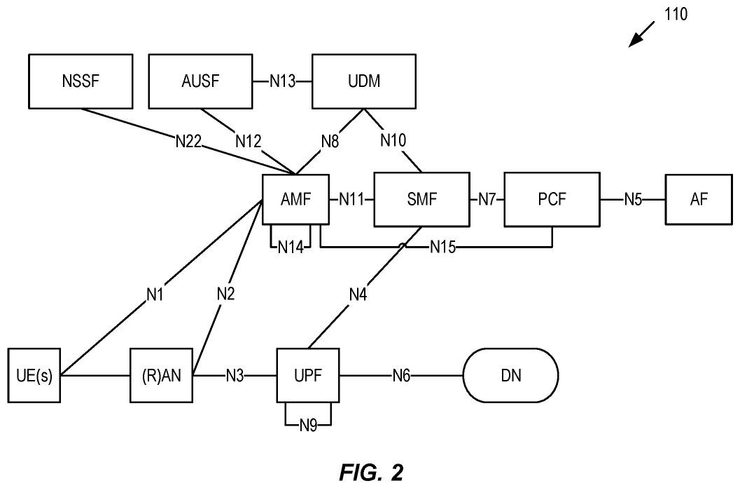

### FIG. 2

FIG. 2 illustrates a wireless communication system represented as a 5G network architecture composed of core Network Functions (NFs), where interaction between any two NFs is represented by a point-to-point reference point/interface. FIG. 2 can be viewed as one particular implementation of the system 100 of FIG. 1.

Seen from the access side the 5G network architecture shown in FIG. 2 comprises a plurality of User Equipment (UEs) connected to either a Radio Access Network (RAN) or an Access Network (AN) as well as an Access and Mobility Management Function (AMF). Typically, the R(AN) comprises base stations, e.g. such as evolved Node Bs (eNBs) or 5G base stations (gNBs) or similar. Seen from the core network side, the 5G core NFs shown in FIG. 2 include a Network Slice Selection Function (NSSF), an Authentication Server Function (AUSF), a Unified Data Management (UDM), an AMF, a Session Management Function (SMF), a Policy Control Function (PCF), and an Application Function (AF).

The PCF supports unified policy framework to govern the network behavior. Specifically, in some embodiments, PCF provides Policy and Charging Control (PCC) rules to the Policy and Charging Enforcement Function (PCEF) (SMF/UPF that enforces policy and charging decisions according to provisioned PCC rules). The SMF supports different functionality, specifically, in some embodiments, SMF receives PCC rules from PCF and configures UPF accordingly. The UPF supports handling of user plane traffic based on the rules received from SMF, specifically, in some embodiments, packet inspection and different enforcement actions (Quality of Service (QoS), Charging, etc.).

Reference point representations of the 5G network architecture are used to develop detailed call flows in the normative standardization. The N1 reference point is defined to carry signaling between the UE and AMF. The reference points for connecting between the AN and AMF and between the AN and UPF are defined as N2 and N3, respectively. There is a reference point, N11, between the AMF and SMF, which implies that the SMF is at least partly controlled by the AMF. N4 is used by the SMF and UPF so that the UPF can be set using the control signal generated by the SMF, and the UPF can report its state to the SMF. N9 is the reference point for the connection between different UPFs, and N14 is the reference point connecting between different AMFs, respectively. N15 and N7 are defined since the PCF applies policy to the AMF and SMP, respectively. N12 is required for the AMF to perform authentication of the UE. N8 and N10 are defined because the subscription data of the UE is required for the AMF and SMF.

The 5G core network aims at separating user plane and control plane. The user plane carries user traffic while the control plane carries signaling in the network. In FIG. 2, the UPF is in the user plane and all other NFs, i.e., the AMF, SMF, PCF, AF, AUSF, and UDM, are in the control plane. Separating the user and control planes guarantees each plane resource to be scaled independently. It also allows UPFs to be deployed separately from control plane functions in a distributed fashion. In this architecture, UPFs may be deployed very close to UEs to shorten the Round Trip Time (RTT) between UEs and data network for some applications requiring low latency.

The core 5G network architecture is composed of modularized functions. For example, the AMF and SMF are independent functions in the control plane. Separated AMF and SMF allow independent evolution and scaling. Other control plane functions like the PCF and AUSF can be separated as shown in FIG. 2. Modularized function design enables the 5G core network to support various services flexibly.

Each NF interacts with another NF directly. It is possible to use intermediate functions to route messages from one NF to another NF. In the control plane, a set of interactions between two NFs is defined as service so that its reuse is possible. This service enables support for modularity. The user plane supports interactions such as forwarding operations between different UPFs.

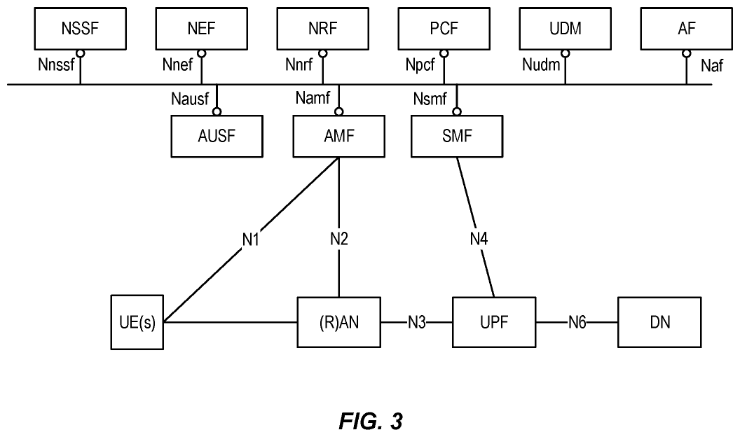

### FIG. 3

FIG. 3 illustrates a 5G network architecture using service-based interfaces between the NFs in the control plane, instead of the point-to-point reference points/interfaces used in the 5G network architecture of FIG. 2. However, the NFs described above with reference to FIG. 2 correspond to the NFs shown in FIG. 3. The service(s) etc. that a NF provides to other authorized NFs can be exposed to the authorized NFs through the service-based interface. In FIG. 3 the service based interfaces are indicated by the letter “N” followed by the name of the NF, e.g. Namf for the service based interface of the AMF and Nsmf for the service based interface of the SMF etc. The Network Exposure Function (NEF) and the Network Function (NF) Repository Function (NRF) in FIG. 3 are not shown in FIG. 2 discussed above. However, it should be clarified that all NFs depicted in FIG. 2 can interact with the NEF and the NRF of FIG. 3 as necessary, though not explicitly indicated in FIG. 2.

Some properties of the NFs shown in FIGS. 2 and 3 may be described in the following manner. The AMF provides UE-based authentication, authorization, mobility management, etc. A UE even using multiple access technologies is basically connected to a single AMF because the AMF is independent of the access technologies. The SMF is responsible for session management and allocates Internet Protocol (IP) addresses to UEs. It also selects and controls the UPF for data transfer. If a UE has multiple sessions, different SMFs may be allocated to each session to manage them individually and possibly provide different functionalities per session. The AF provides information on the packet flow to the PCF responsible for policy control in order to support Quality of Service (QoS). Based on the information, the PCF determines policies about mobility and session management to make the AMF and SMF operate properly. The AUSF supports authentication function for UEs or similar and thus stores data for authentication of UEs or similar while the UDM stores subscription data of the UE. The Data Network (DN), not part of the 5G core network, provides Internet access or operator services and similar.

An NF may be implemented either as a network element on a dedicated hardware, as a software instance running on a dedicated hardware, or as a virtualized function instantiated on an appropriate platform, e.g., a cloud infrastructure.

Network Address Translation (NAT) is a method of remapping one Internet Protocol (IP) address space into another IP address space by modifying network address information in the IP header of packets while they are in transit across a traffic routing device. Network Address and Port Translation (NAPT) also includes modifying the source port in the transport header. The NAT and the NAPT operate in a similar or corresponding manner.

NAT provides a translation technology which allows multiple end customers to use common and overlapping private IP address ranges internally. Any number of end customers can use the same private IP address ranges. To route to external Internet IP addresses, NAT translates the private IP addresses to public IP addresses, e.g. NAT44 which translates from private to public IPv4 address needed to cope with IPv4 address depletion.

With the advent of enterprise and home solutions and migration to IPv6, Service providers have deployed Carrier Grade NAT (CGNAT) which provides additional NAT schemes such as NAT64 or NAT444.

Since NAT can break some upper application protocols which include the IP address value in their signaling (e.g. File Transfer Protocol (FTP), Session Initiation Protocol (SIP)), CGNAT needs to support Application Level Gateway (ALG) which modifies those protocols. CGNAT servers are usually deployed in the service provider service LAN. Improved systems and methods for providing network address translation are needed.

Recently, 3GPP Rel16 has standardized the support of Multipath Transmission Control Protocol (MPTCP) proxy in UPF as a method for UE and UPF steering the traffic on 3GPP or non 3GPP access. With such a solution, when a UE sets a Multi-access session with 5GC, the SMF, in addition to the public PDU session IP address, assigns two link specific addresses (not routable over N6) to the UE to be used only for the MPTCP sub-flow in each access. 3GPP has defined N4 MAR rule extensions to enable such proxy.

However, there may be problems on different NAT applicability areas. Existing CGNAT uses case deployments and the new multi-access solution (ATSSS) defined in 3GPP Re116. Refer to 3GPP TS 23.502 for details.

CGNAT deployments face some challenges:
a. CGNAT entities are usually highly loaded and costly; they need to receive all traffic from millions of subscribers even if for many Use Cases the NAT method to apply is relatively simple.
b. In most cases, country regulatory laws require that service providers log subscriber activity including NATed IP addresses and subscriber identities. This forces service providers to integrate CGNAT with other network entities which can provide the subscriber identity.

Since CGNAT is considered an N6 LAN service, 3GPP does not currently support NAT policies in the existing policy framework. Additionally, the UPF does not support NAT enforcement (based on the above NAT policies).

In the case of the 3GPP Rel16 ATSSS solution with MPTCP method, the use of private IPs for MPTCP traffic between UE and UPF forces UPF to NAT uplink traffic (from MPTCP proxy function to N6), and downlink traffic (from N6 to MPTCP proxy function). Such NATing is not addressed by current N4 ATSSS extensions.

Also, when Control Plane and User Plane Separate (CUPS) is applied, it might be unclear how the UP function should handle those user plane IP packets requiring NAT function, including allocation/deallocation of one or more of the NAT IP address(es) and/or Port. At user session activation, NAT IP addresses are allocated to the UE by the PGW even if some service is seldom used, such as a Wireless Application Protocol (WAP), or some service isn't used until session is activated for a long time. NAT IP resource allocated since session establishment is a waste of resources in these scenarios.

Systems and methods for supporting NAT are provided. In some embodiments, there is a mechanism to enable a Control Plane (CP) function to instruct a User Plane (UP) function to apply NAT function for at least one specific service data flow for a given Packet Flow Control Protocol (PFCP) session, in 5GC and/or EPC, when the CP function and UP function is separated. In some embodiments, this is accomplished by a new UP function feature, which in some embodiments is called “Support of Network Address Translation in UP function” (NATU). In some embodiments, a new feature bit can be defined in the IE “UP function features” as specified in 8.2.25 of 3GPP TS 29.244. In some embodiments, the PFCP protocol is extended by creating a new NAT IE in the Forwarding Parameters IE in the Forwarding Action Rule (FAR). Some embodiments involve enhancements in the 3GPP N4 interface, but also in Npcf and Nudr interfaces.

The embodiments of the current disclosure might result in one or more improvements such as: introducing a mechanism to allow CP function to instruct UP function to perform NAT function for one or more service data flow(s), when CP and UP function are separated; using NAT function can protect a private network from potential unlawful incursion; and delaying NAT IP address and port allocation and withdraw at the service initiation and termination can save the public IP address space.

Also, embodiments of the current disclosure might result in one or more improvements such as allowing the network operator to support NAT policies in the context of 4G/5G networks supporting CUPS. This is of value, e.g., for ATSSS functionality where SMF can program the translation from link specific address to the public IP address assigned to the Multi-access PDU session.

Some embodiments allow the network operator to support NAT policies with different granularity: on a per global basis, on a per subscriber basis, on a per Data Network Name (DNN) basis, per PDU session basis; per data flow basis and/or on a per application basis. In addition, existing UPF subscriber awareness and upper application protocol inspection can be leveraged to provide subscriber aware NAT logs or Application aware NATing which are difficult to achieve with standalone CGNAT solutions. Some embodiments allow the network operator to support NAT enforcement in the UPF. This avoids the need of any external NAT SF or at least allows offloading external CGNAT of certain NATing use cases.

When traffic related to a single UE device and one APN is divided and routed to several VPNs, such as Internet, WAP, or other enterprise VPN, routing can present ambiguity if UE uses only one IP address. As a result, multiple return paths exist for responding packets, and payload can be returned to a different VPN from the one where it originated.

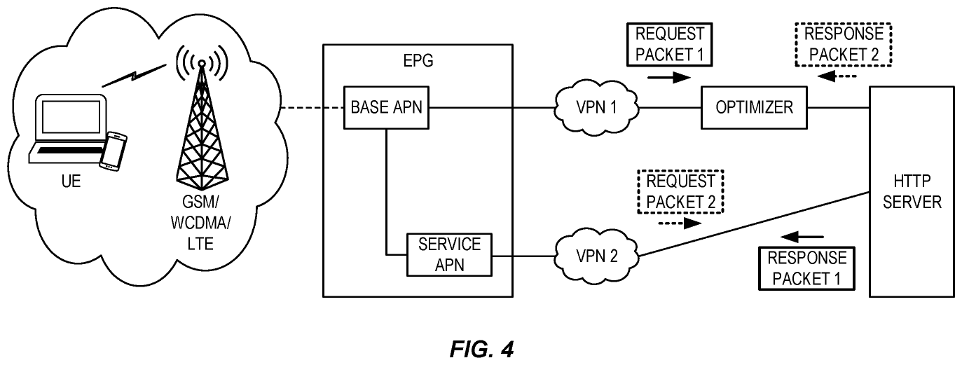

### FIG. 4

In order to remove such ambiguities, NAT can be enabled for service VPNs by the configuration of one or more IP address ranges containing addresses that substitute the original source IP address. FIG. 4 illustrates an example where multiple VPNs can cause ambiguity. For instance, FIG. 4 shows the response to packet 2 returning over VPN 1 even though the request packet 2 came from VPN 2. Similarly, the response to packet 1 is shown returning over VPN 2 even though the request packet 1 came from VPN 1. Improved systems and methods for providing network address translation are needed.

At user session activation, the Evolved Packet Gateway (EPG) allocates a unique IP address to the UE on each service VPN allowed on the base APN for which NAT is enabled. The addresses are allocated from either the shared address pool locally or RADIUS. After deactivation of the UE session, the IP addresses are withdrawing and available for allocation to another UE.

When the EPG receives an uplink packet that is detected according to the traffic class of the data packet and should be routed to a service VPN for which NAT is enabled, it replaces the original source IP address in the IP header of the packet with the NAT IP address allocated to the UE. On return of the payload, the NAT IP address in the destination field of the packet is replaced with the original UE IP address.

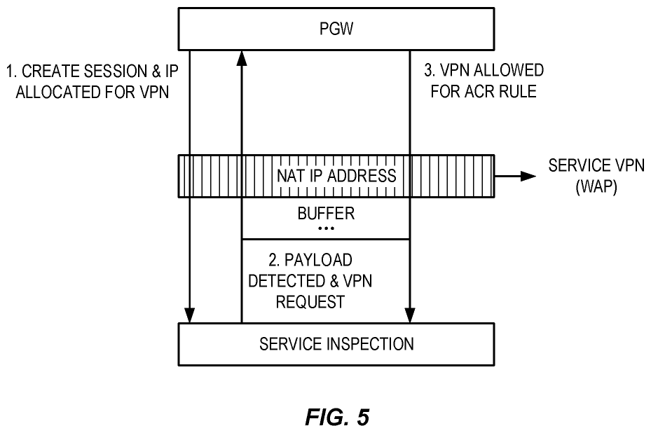

### FIG. 5

FIG. 5 illustrates an example where the NAT IP allocated is marked by stippling in step 1 of FIG. 5. However, the NAT IP isn't used until payload detected in step 2 and a specific PCC rule is associated and allowed in step 3.

In a first embodiment, it is expected that the UP function is self-conducted to handle user plane packets applicable for NAT, with a little less instruction from the CP function. In some embodiments, this includes one or more of:
a. During PFCP Association Setup/Update procedures, the UP function indicates its support of NATU;
b. the CP function indicates that the NAT function may be required for the said PFCP session when an indication provision at the PFCP session level, i.e. NAT function, is applicable for all the traffic controlled by the said PFCP session, or for traffic received from/sent towards certain network domain or interface which is identified by a Network Instance IE or Source/Destination Interface IE(s) if such indication is provisioned associated with a Network Instance and/or Source/Destination Interface. Such indication may be the presence of a new IE, preferably called “NAT Address and/or Port” and/or a new indication preferably called “NAT require” which gives UP function explicit indication. As said, such indication may be provisioned at PFCP session level, e.g. be included in PFCP session establishment request message level, or be associated with Destination/Source Interface and/or Network Instance, e.g. be included in a DL PDR.
c. Upon receiving a user plane IP packet, e.g. from a network instance, where a NAT indication is set, i.e. the user plane packets matches a Packet Detection Rule (PDR) which is provisioned to match user plane traffic from the said network instance (It is assumed the packets from the said Network Instance may be always Downlink packets sent towards UE), the UP function shall replace the Destination IP address and/or Port number with the real UE IP address, which is set by the existing IE UE IP address; similarly, towards a network instance, where a NAT indication is set, i.e. the user plane packets are forwarded towards the said network instance based on the FAR (It is assumed the packets towards the said Network Instance may be always Uplink packets sent towards a specific service Packet Data Network), the UP function shall replace the Source IP address and/or Port number with the NAT IP address and/or port, which is provisioned with the new IE “NAT Address and/or Port” associated with the said Network Instance.

In some embodiments, this approach requires UP function to replace Source or Destination IP address with NAT Address or real UE IP address based on Uplink or Downlink traffic smartly.

In a second embodiment, it is expected that the UP function is fully instructed by the CP function to perform IP header modifications, e.g. replace/change source/destination IP address and/or Port. In some embodiments, this includes one or more of:
a. During PFCP Association Setup/Update procedures, the UP function indicates its support of NATU, but in this alternative, the UP is just expected to support the follow new IEs as described below.
b. CP function provisions one PDR for UL and one PDR for DL to match the user plane packets for a service (so those user plane packets matching the PDR pertain to the service data flow for the said service/application);
c. CP function provisions a Usage Reporting Rule to request UP function to generate a report to report the detection of the service traffic;
d. CP function associates the Usage Reporting Rule (URR) (created in step 2) with the PDRs (created in step 1)
e. UP Function detects user plane packets matching the PDRs and send reports to the CP function;
f. Based on the local configuration or by initiating signaling towards a AAA/Radius server, the CP function gets a NAT IP address and/or a port, e.g. 183.1.50.4 as in the following figure for telematics service, if NAT function (as described step 0) is supported in UP function which is indicated via the UP Function Features IE to CP function
g. The CP function, provisions the following controlling rule in a PFCP session Modification (Establishment) request message:
   i. A new DL PDR to identify the PFCP session, which includes:
      1. A new IE preferably called NAT IP Address or more generally, additional UE IP address, which is associated with a specific Network Instance to enable the PDR to match only the traffic from a specific service VPN; or alternatively
      2. Reuse existing IE Framed-Route (or Framed-IPv6-Route), which is also associated with a specific Network Instance to enable the PDR to match only the traffic from a specific service VPN;
   ii. To match traffic from a specific service VPN, a new DL PDR is created with relevant Service Data Filter or application ID to match the traffic from a specific network instance dedicated to the service VPN;
   iii. A new FAR is created to be associated with the DL PDR (created in the step b)
      1. a new IE preferably called “IP header Modification IE” indicating the UPF shall replace the Destination IP address and/or Destination Port of the user plane packet which is NAT IP address (e.g. 183.1.50.4) to the real UE IP address (196.120.0.4) and the source Port (used when UE initiates UL traffic, see el); or alternatively
      2. reuse existing IE Outer Header Creation, with adding a new value indicating the UPF shall replace the Destination IP address and Destination Port of the user plane packet which is NAT IP address (e.g. 183.1.50.4) to the real UE IP address (196.120.0.4) and the suitable Port the source Port (used when UE initiates UL traffic, see el);
      3. reuse existing IE Forwarding Policy, which points a locally configured policy identifier indicating the same but, in this case, the NAT IP address and port cannot be dynamically provisioned by the CP function via this IE, i.e. such NAT IP and/or Port information has to be preconfigured in the UP function in corresponding to the Forwarding Policy ID

Similarly, for UL traffic:
a. To match the traffic towards a specific service APN, a new UL PDR is to be created; the UL PDR is created with relevant Service Data Filter or application ID to match the traffic from the UE towards a specific network instance dedicated to the service APN.) A new FAR to be associated with the UL PDR, where in the new FAR, it includes a new Network Instance enabling traffic to be sent towards a service VPN, in addition:
   i. a new IE indicating the UPF shall replace the source IP address and source Port of the user plane packet (e.g. 196.120.0.4) to the NAT IP address (183.1.50.4) and NAT Port; or alternatively
   ii. reuse existing IE Outer Header Creation, with a new value indicating the UPF shall replace the source IP address and source Port of the user plane packet to the NAT IP address and NAT Port; or alternatively
   iii. reuse existing IE Forwarding Policy, which points a locally configured policy identifier indicating the same but, in this case, the NAT IP address and port cannot be dynamically provisioned by the CP function via this IE, i.e. such NAT IP and/or Port information has to be preconfigured in the UP function in corresponding to the Forwarding Policy ID

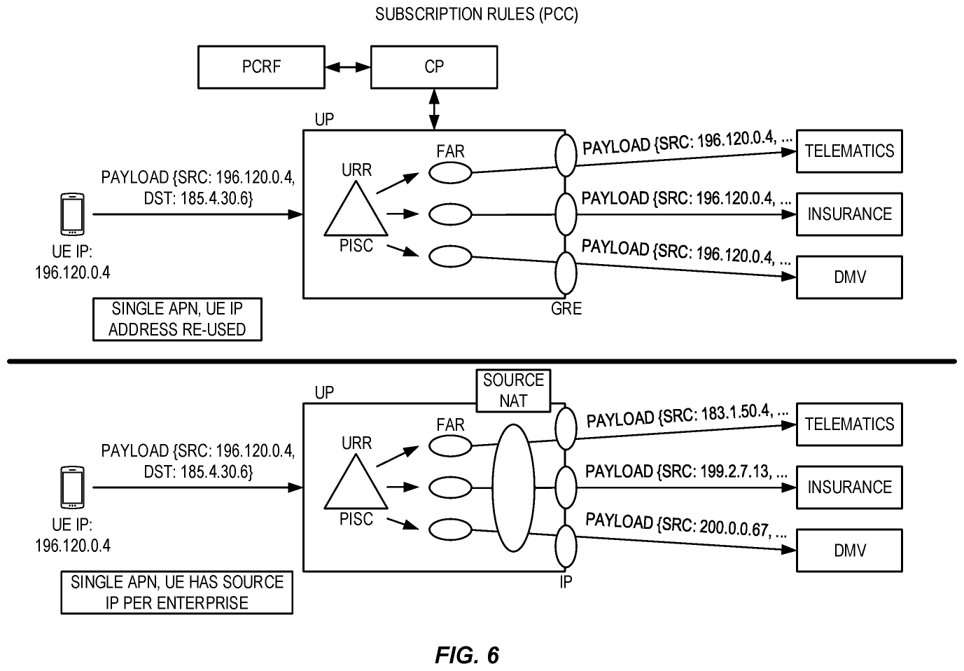

### FIG. 6

FIG. 6 illustrates an example system without and with NAT IP address. The top of the figure does not use NAT and the UE IP address is re-used. Each of the three payloads shows the same source IP (196.120.0.4 in this example). In contrast, the bottom of the figure uses NAT and the UE has a source IP address per enterprise. Each of the three payloads shows different source IP addresses (183.1.50.4, 199.2.7.13 and 200.0.0.67 respectively in this example).

In some embodiments, feature support of NATU can be negotiated between the CP and the UP function. This might involve the NAT function (e.g., “NATU” in Octet/Bit as 6/8) in the UP Function Features IE to describe whether the NAT function can be applied or not in the UP function. For example, the UP function may indicate that it supports NAT by setting a flag or a bit mask e.g. in the form of one or more Bit(s) (c.f. the “NATU”) in an IE e.g. in the UP Function Features IE and send the IE towards the CP function in a suitable message. For example, when the CP function requires “NATU” via PFCP Association Setup or Update Request, the UP function may indicate support of NAT function by setting the “NATU” flag in the UP Function Features IE via PFCP Association Setup or Update Response.

If “NATU” is supported in the UP function, the CP function may include the NAT IP address and/or port information in PDR associated to the PDU session and provide the PDR to the UP Function. The NAT address and/or port information may e.g., be obtained by the CP function via SGi/Radius or may be preconfigured in the CP function or in the UP function. In some embodiments, the NAT address and/or port information provided by the CP function shall prevail over NAT address and/or port information preconfigured in the UP function.

If “NATU” is not supported in the UP function, the flag is set as 0 via UP Function Features IE and CP Function will not apply NAT for this UP Function.

The Table below illustrates how the NATU feature could be added to the UP Function Features IE. However, the current disclosure is not limited to this implementation:

| Feature | | | |
|---|---|---|---|
| Octet/Bit | Feature | Interface | Description |
| 5/1 | BUCP | Sxa, N4 | Downlink Data Buffering in CP |
| | | | function is supported by the UP |
| | | | function. |
| 5/2 | DDND | Sxa, N4 | The buffering parameter ‘Downlink |
| | | | Data Notification Delay’ is |
| | | | supported by the UP function. |
| . . . | . . . | . . . | . . . |
| 6/8 | NATU | Sxb, Sxc, N4 | (Source) Network Address (and Port) |
| | | | Translation is supported by the UP |
| | | | function. |

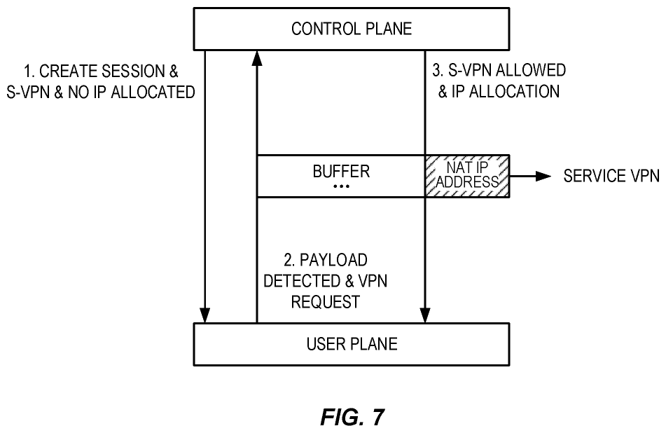

### FIG. 7

In some embodiments, instead of all NAT IP addresses and ports for relevant Service VPNs being allocated at session creation, the PGW allocates NAT IP address and ports for service VPNs only when the packets are detected, and the associated PCC rule is activated. The associated PCC rule can be activated by PCRF or local policy without PCRF. FIG. 7 illustrates an example of NAT IP allocation on service access.

For the CUPS case, a Usage Reporting Rule (URR) with reporting trigger START is sent to the UP Function when session creation/modification for Usage Report informing specific application detected with Application ID. Once an application is detected, the UP function sends the Usage Report with START trigger to inform CP function. The payload is buffered by default or dropped depending on its configuration in the UP function until the NAT IP address and Port is allocated. If no service is detected, the original Network Instance is used for payload routing.

When the PGW-C receives the Usage Report with trigger START, the PGW-C will associate the PCC rule. If the PCC rule is activated, the PGW-C will allocate the NAT IP address and Port, which come from the local shared IP pool or Radius. The PGW-C will package the NAT IP address and Port into PDR/FAR for the UP function to deliver the payload. After receiving the NAT IP address and port, the UP function can deliver the payload based on NAT IP address and port. NAT IP allocation on service access is of higher priority if provided.

In some embodiments, the PGW-C is responsible for maintenance of NAT IP mapping between UE IP Addresses and NAT IP Addresses. The PGW-C informs the UP Function for replacement of the UE IP Address by the given NAT IP Address by PDR/FAR associated to the PDU session. In addition, the packets buffered before NAT IP allocation will be delivered to the Service VPN.

In some embodiments, the NAT IP address and port are in the PDR. The NAT IP address and port can be delivered to the UP function using several options. In a first option, a new IE, preferably called “NAT IP Address Port” or “Additional UE IP Address Port” is introduced in the Packet Detection Information (PDI) or Create Traffic Endpoint IE for a downlink (DL) PDR. An example of this new IE which contains a source or destination IP address is included below:

| | Bits | | | | | | | |
|---|---|---|---|---|---|---|---|---|
| Octets | 8 | 7 | 6 | 5 | 4 | 3 | 2 | 1 |

| 1 to 2 | Type = aa (decimal) | | |
|---|---|---|---|
| 3 to 4 | Length = n | | |
| 5 | Spare | V4 | V6 |

| | |
|---|---|
| m to (m + 3) | IPv4 address |
| p to (p + 15) | IPv6 address |
| r | Port number |
| k to (n + 4) | These octet(s) is/are present only if explicitly |
| | specified |

The following flags are coded within Octet 5:
a. Bit 1— V6: If this bit is set to “1”, then the IPv6 address field shall be present in the UE IP Address, otherwise the IPv6 address field shall not be present.
b. Bit 2— V4: If this bit is set to “1”, then the IPv4 address field shall be present in the UE IP Address, otherwise the IPv4 address field shall not be present.

An example of a new IP header Modification IE which contains a source or destination IP address is included below:

| | Bits | | | | | | | |
|---|---|---|---|---|---|---|---|---|
| Octets | 8 | 7 | 6 | 5 | 4 | 3 | 2 | 1 |

| 1 to 2 | Type = aa (decimal) | | | | |
|---|---|---|---|---|---|
| 3 to 4 | Length = n | | | | |
| 5 | Spare | RES | RED | V4 | V6 |

| | |
|---|---|
| m to (m + 3) | IPv4 address |
| p to (p + 15) | IPv6 address |
| r | Port number |
| k to (n + 4) | These octet(s) is/are present only if explicitly |
| | specified |

The following flags are coded within Octet 5:
a. Bit 1— V6: If this bit is set to “1”, then the IPv6 address field shall be present in the UE IP Address, otherwise the IPv6 address field shall not be present.
b. Bit 2— V4: If this bit is set to “1”, then the IPv4 address field shall be present in the UE IP Address, otherwise the IPv4 address field shall not be present.
c. Bit 3— RED: If this bit is set to “1”, the included IPv4 or IPv6 address in octets (m to m+3) and (p to p+15) respectively shall be used to replace destination IP address.
d. Bit 4— RED: If this bit is set to “1”, the included IPv4 or IPv6 address in octets (m to m+3) and (p to p+15) respectively shall be used to replace destination IP address

An example of a reuse of the existing IE Create Outer Header which contains the instructions to create an Outer Header is included below:

| | Bits | | | | | | | |
|---|---|---|---|---|---|---|---|---|
| Octets | 8 | 7 | 6 | 5 | 4 | 3 | 2 | 1 |

| | |
|---|---|
| 1 to 2 | Type = 84 (decimal) |
| 3 to 4 | Length = n |
| 5 to 6 | Outer Header Creation Description |
| m to (m + 3) | TEID |
| p to (p + 3) | IPv4 Address |
| q to (q + 15) | IPv6 Address |
| r to (r + 1) | Port Number |
| t to (t + 2) | C-TAG |
| u to (u + 2) | S-TAG |
| s to (n + 4) | These octet(s) is/are present only if explicitly |
| | specified |

The Outer Header Creation Description field, when present, shall be encoded as specified in Table 8.2.56-1. It takes the form of a bitmask where each bit indicates the outer header to be created in the outgoing packet. Spare bits shall be ignored by the receiver.

The Outer Header Creation Description is included below:

| Octet/Bit | Outer Header to be created in the outgoing packet |
|---|---|
| 5/1 | GTP-U/UDP/IPv4 (NOTE 1), (NOTE 3) |
| 5/2 | GTP-U/UDP/IPv6 (NOTE 1), (NOTE 3) |
| 5/3 | UDP/IPv4 (NOTE 2, NOTE 5) |
| 5/4 | UDP/IPv6 (NOTE 2, NOTE 5) |
| 5/5 | IPv4 (NOTE 5) |
| 5/6 | IPv6 (NOTE 5) |
| 5/7 | C-TAG (see NOTE 4) |
| 5/8 | S-TAG (see NOTE 4) |
| 6/1 | Replace the Source IPv4 address with the IPv4 address included in p to (p + 3) |
| | and port number in r to (r + 1) |
| 6/1 | Replace the Source IPv6 address with the IPv6 address included in q to (q + 15) |
| | and port number in r to (r + 1) |
| 6/3 | Replace the Destination IPv4 address with the IPv4 address included in p to |
| | (p + 3) and port number in r to (r + 1) |
| 6/4 | Replace the Destination IPv6 address with the IPv6 address included in q to |
| | (q + 15) and port number in r to (r + 1) |

NOTE1:
The SGW-U/I-UPF shall also create GTP-U extension header(s) if any has been stored for this packet, during a previous outer header removal (see subclause 8.2.64).
NOTE 2:
This value may apply to UL packets sent by a PGW-U for non-IP PDN connections with SGi tunnelling based on UDP/IP encapsulation (see subclause 4.3.17.8.3.3.2 of 3GPP TS 23.401 [14]).
NOTE 3:
The SGW-U/I-UPF shall set the GTP-U message type to the value stored during the previous outer header removal.
NOTE 4:
This value may apply to UL packets sent by a UPF for Ethernet PDU sessions over N6 (see subclause 5.8.2.11.6 of 3GPP TS 23.501 [28]).
NOTE 5:
This value may apply e.g. to UL packets sent by a UPF (PDU Session Anchor) over N6, when explicit N6 traffic routing information is provided to the SMF (see subclause 5.6.7 of 3GPP TS 23.501 [28]).

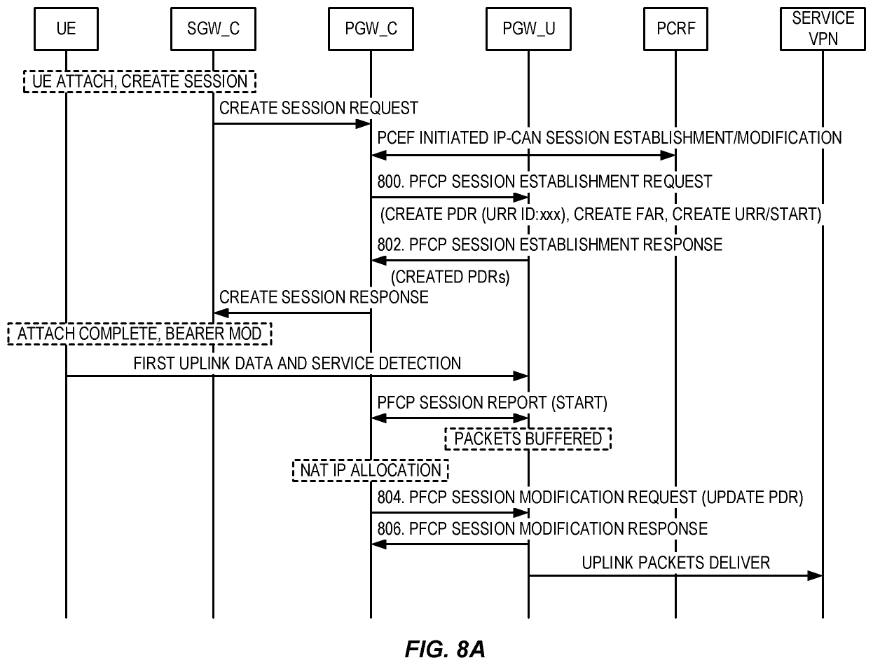

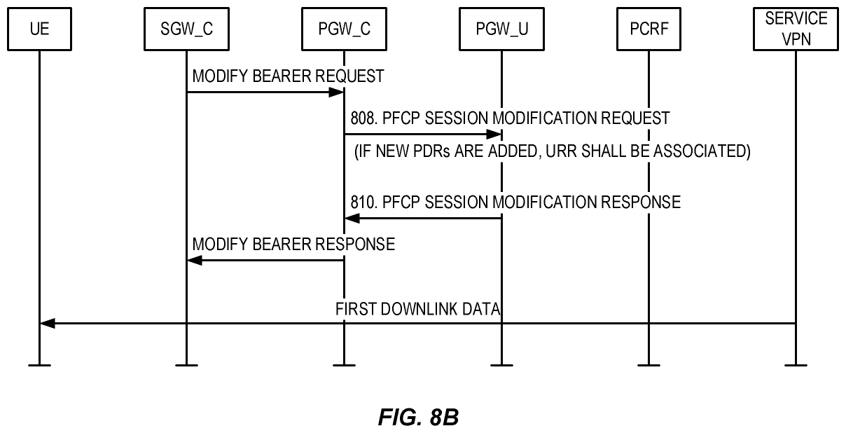

### FIGS. 8A and 8B

FIGS. 8A and 8B illustrate an exemplary embodiment for PFCP interaction. This illustrates PDR/FAR/URR for application start detection when the session is created. Note that this illustration relates to the EPC core network as will be discussed in more detail below. As shown, a wireless device such as a UE has optionally performed an attach procedure and potentially created a session with the SGW-C which then sends a Create Session Request to the PGW-C. During the Session Establishment, the PGW-C(or any other suitable CP entity) can send a PFCP Session Establishment Request to the PGW-U (or any other suitable UP entity) (step 800). This request may include creation of PDR, creation of FAR, and/or creation of URR/START. The PGW-U sends a PFCP Session Establishment Response to the PGW-C(step 802). The response might include the created PDRs. Later, after the first uplink data and/or service detection, a PFCF Session Report is set up. After NAT IP allocation, the PGW-C sends a PFCP Session Modification Request to the PGW-U (step 804). This may include an indication to update the PDR. The PGW-U sends the PFCP Session Modification Response to the PGW-C(step 806). In addition or instead, after the SGW-C sends a Modify Bearer Request to the PGW-C, the PGW-C sends a PFCP Session Modification Request to the PGW-U (step 808). If new PDRs are added, this may include an indication that URR shall be associated. The PGW-U sends the PFCP Session Modification Response to the PGW-C(step 810).

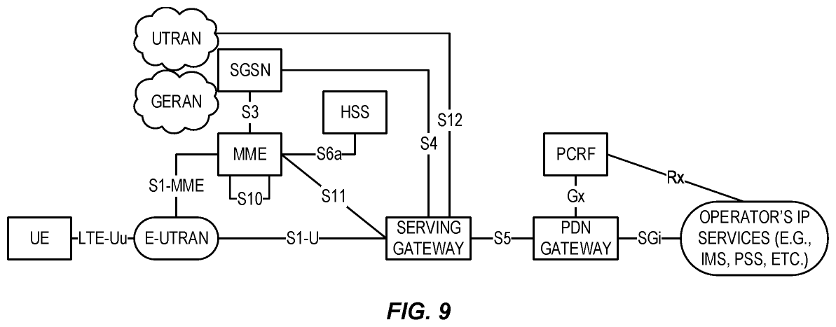

### FIG. 9

FIG. 9 illustrates an example of the EPC core network.

### FIG. 10

Additionally, FIG. 10 illustrates an example reflecting Control Plane and User Plane separation. FIG. 10 shows the architecture reference model in the case of separation between control plane and user plane. This architecture reference model covers non-roaming as well as home routed and local breakout roaming scenarios. In particular, it may be noted that the PDN Gateway (PGW) has been split up in a PDN Gateway-C(PGW-C) and a PDN Gateway-U (PGW-U). The PGW-C and the PGW-U may communicate via the Sxb interface.

While the previous discussion focused on the EPC core network, the principles are also applicable to the 5G core network, which was discussed above in relation to FIGS. 2 and 3. In some embodiments, some of the functions of the 4G PGW have been split between the PGW-C and PGW-U, and in 5G, PGW-C becomes SMF, and PGW-U becomes UPF. The UPFs are handling user plane traffic under the SMF's control.

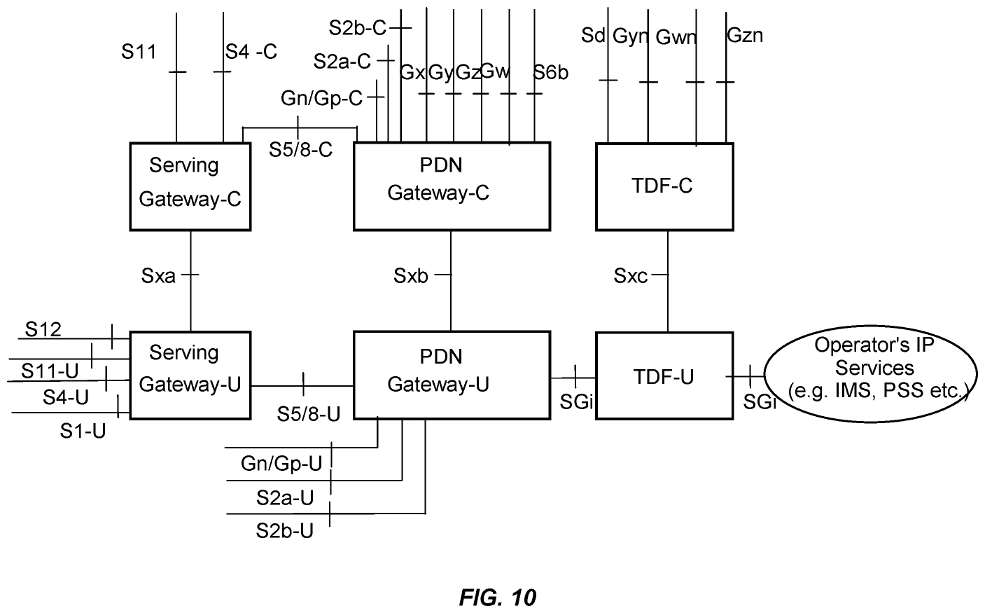

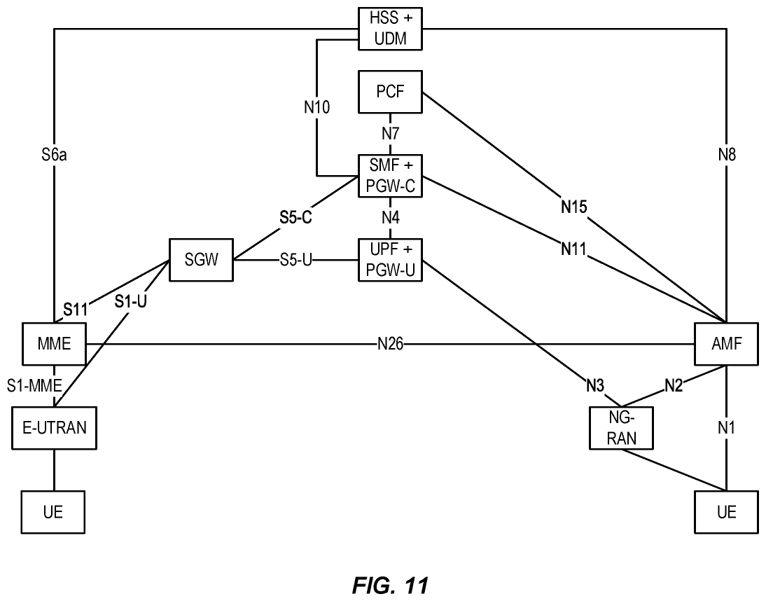

### FIG. 11

In some embodiments, a combined SMF/PGW-C is assumed, i.e., in connection with interworking between 4G and 5G networks. In this case, the UPF needs to also support Sxb (to communicate with PGW-C). FIG. 11 illustrates an example of such a 4G and 5G interworking architecture. In some embodiments, the PGW with split UP (PGW-U) and CP (PGW-C) should/can be seen as a split SMF and UPF. In some embodiments, there is no combined SMF and UPF.

In some embodiments, the solutions consist of an extension of 3GPP PFCP protocol by creating a new NAT IE in the Forwarding Parameters IE in the FAR. This allows the SMF to instruct the UPF to enforce NAT policies. In some embodiments, additional extensions are required in Npcf and Nudr interfaces to carry the NAT policies to the UPF, which will use it to apply (source) NAT enforcement for a user's traffic. In some embodiments, the NAT IP address pool is handled in SMF. In some embodiments, the NAT IP address pool is handled in UPF.

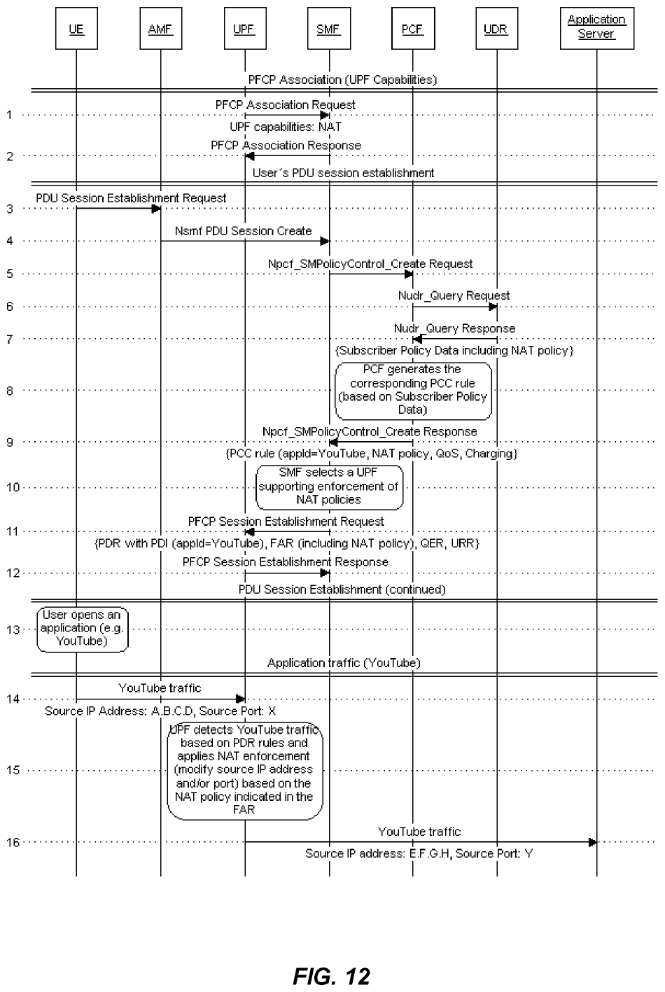

### FIG. 12

FIG. 12 illustrates the example of NAT policies configured on a per subscriber basis and when NAT IP address pool is handled in SMF. The procedure in FIG. 12 assumes that the NAT policy is preconfigured in UDR as subscriber policy data and that the NAT IP address pool is configured at SMF. Steps 1 and 2 illustrate: At the PFCP Association procedure between UPF and SMF entities, the existing mechanism to report UPF capabilities is extended with a new capability (NAT enforcement: NATU, e.g., see the UP Function Features IE table above). This would allow the SMF to know which UPFs support this capability and thus can exert influence on UPF selection.

Steps 3 and 4 illustrate: the UE triggers a PDU session establishment, by means of sending a PDU Session Establishment Request to the AMF. The AMF selects an SMF to manage the PDU session (the SMF selection function in the AMF selects an SMF instance based on the available SMF instances obtained from NRF or on the configured SMF information in the AMF) and triggers an Nsmf PDU Session Create. Note that the sequence diagram in FIG. 12 does not include all the signaling messages involved in the PDU Session Establishment procedure.

Step 5 illustrates: The SMF triggers an Npcf_SMPolicyControl_Create Request message to retrieve SM policies for the user PDU session. Step 6 illustrates: The PCF triggers an Nudr_Query Request message to retrieve the Subscriber policy data associated with the UE for this PDU session.

Step 7 illustrates: The UDR answers with an Nudr_Query Response message including the Subscriber Policy Data, which includes a NAT policy. This NAT policy might include the need to additionally run ALG functionality. Step 8 illustrates: The PCF generates the corresponding PCC rule/s based on Subscriber Policy Data.

Step 9 illustrates: Based on the above, The PCF triggers an Npcf_SMPolicyControl_Create Response message including the PCC rules to be applied for this user PDU session. In this case, as an example, there will be a PCC rule for YouTube application including some enforcement actions (NAT, Charging and QoS).

Step 10 illustrates: Based on the PCC rule/s received from PCF (which include or at least indicate NAT policies), SMF selects a UPF supporting enforcement of NAT policies. Step 11 illustrates: The SMF triggers a PFCP Session Establishment Request message including the corresponding PCC rule(s) (PDRs/FARs/QERs/URRs). In this example, there will be a PDR with PDI of type application with appld=YouTube, and a corresponding FAR, QER and URR. It is proposed to extend the FAR by creating a new Network Address Translation IE in the Forwarding Parameters IE as shown below:

Octet 1 and 2 Forwarding Parameters IE Type = 4 (decimal)
Octets 3 and 4 Length = n

| Information | | | Appl. | | | | |
|---|---|---|---|---|---|---|---|
| elements | P | Condition/Comment | Sxa | Sxb | Sxc | N4 | IE Type |
| Destination | M | This IE shall identify the destination interface of the | X | X | X | X | Destination |
| Interface | | outgoing packet. | | | | | Interface |
| Network | O | When present, this IE shall identify the Network | X | X | X | X | Network |
| Instance | | instance towards which to send the outgoing packet. | | | | | Instance |
| | | See NOTE 1. | | | | | |
| Redirect | C | This IE shall be present if the UP function is required | — | X | X | X | Redirect |
| Information | | to enforce traffic redirection towards a redirect | | | | | Information |
| | | destination provided by the CP function. | | | | | |
| Outer Header | C | This IE shall be present if the UP function is required | X | X | — | X | Outer Header |
| Creation | | to add one or more outer header(s) to the outgoing | | | | | Creation |
| | | packet. If present, it shall contain the F-TEID of the | | | | | |
| | | remote GTP-U peer when adding a GTP-U/UDP/IP | | | | | |
| | | header, or the Destination IP address and/or Port | | | | | |
| | | Number when adding a UDP/IP header or an IP | | | | | |
| | | header or the C-TAG/S-TAG (for 5GC). | | | | | |
| | | See NOTE 2. | | | | | |
| Transport Level | C | This IE shall be present if the UP function is required | X | X | — | X | Transport |
| Marking | | to mark the IP header with the DSCP marking as | | | | | Level Marking |
| | | defined by IETF RFC 2474 [22]. When present for | | | | | |
| | | EPC, it shall contain the value of the DSCP in the | | | | | |
| | | TOS/Traffic Class field set based on the QCI, and | | | | | |
| | | optionally the ARP priority level, of the associated | | | | | |
| | | EPS bearer, as described in subclause 5.10 of | | | | | |
| | | 3GPP TS 23.214 [2]. When present for 5GC, it shall | | | | | |
| | | contain the value of the DSCP in the TOS/Traffic | | | | | |
| | | Class field set based on the 5QI, the Priority Level (if | | | | | |
| | | explicitly signalled), and optionally the ARP priority | | | | | |
| | | level, of the associated QoS flow, as described in | | | | | |
| | | subclause 5.8.2.7 of 3GPP TS 23.501 [28], | | | | | |
| Forwarding | C | This IE shall be present if a specific forwarding | — | X | X | X | Forwarding |
| Policy | | policy is required to be applied to the packets. It | | | | | Policy |
| | | shall be present if the Destination Interface IE is set | | | | | |
| | | to SGi-LAN/N6-LAN. It may be present if the | | | | | |
| | | Destination Interface is set to Core, Access, or CP- | | | | | |
| | | Function. See NOTE 2. | | | | | |
| | | When present, it shall contain an Identifier of the | | | | | |
| | | Forwarding Policy locally configured in the UP | | | | | |
| | | function. | | | | | |
| Header | O | This IE may be present if the UP function indicated | — | X | X | X | Header |
| Enrichment | | support of Header Enrichment of UL traffic. When | | | | | Enrichment |
| | | present, it shall contain information for header | | | | | |
| | | enrichment. | | | | | |
| Linked Traffic | C | This IE may be present, if it is available and the UP | X | X | — | X | Traffic |
| Endpoint ID | | function indicated support of the PDI optimisation | | | | | Endpoint ID |
| | | feature, (see subclause 8.2.25). When present, it | | | | | |
| | | shall identify the Traffic Endpoint ID allocated for this | | | | | |
| | | PFCP session to receive the traffic in the reverse | | | | | |
| | | direction (see subclause 5.2.3.1). | | | | | |
| Proxying | C | This IE shall be present if proxying is to be | — | — | — | X | Proxying |
| | | performed by the UP function. | | | | | |
| | | When present, this IE shall contain the information | | | | | |
| | | that the UPF shall respond to Address Resolution | | | | | |
| | | Protocol and/or IPv6 Neighbour Solicitation based | | | | | |
| | | on the local cache information for the Ethernet | | | | | |
| | | PDUs. | | | | | |
| Network Address | O | This IE may be present if the UP function indicated | — | X | X | X | Network |
| Translation | | support of Network Address Translation. When | | | | | Address |
| | | present, it shall contain information for Network | | | | | Translation |
| | | Address Translation. | | | | | |

As an example, the “Network Address Translation” IE is proposed to have the following contents (information related to Dort translation may be present but is not included for simplicity):

| | Bits | | | | | | | |
|---|---|---|---|---|---|---|---|---|
| Octets | 8 | 7 | 6 | 5 | 4 | 3 | 2 | 1 |

| 1-2 | Type = xx (decimal) | | |
|---|---|---|---|
| 3-4 | Length = n | | |
| 5 | Spare | Ext | Address Type |

| 6-7 | Address Length = a | |
|---|---|---|
| 8-(8 + a) | Address | |
| (8 + a + 1) | Spare | Address Type |

| | |
|---|---|
| (8 + a + 2)- | Address Length = b |
| (8 + a + 3) | |
| (8 + a + 4)- | Address |
| (8 + a + 4 + b) | |
| (8 + a + b + 5) | These octet(s) is/are present only if explicitly |
| to (n + 4) | specified |

“Address Type” indicates the type of Address. It is proposed to be encoded as follows:

| | Value |
|---|---|
| Address Type | (Decimal) |
| IPv4 address | 0 |
| IPv6 address | 1 |
| Spare, for future use. | 4 to 15 |

“Address Length” indicates the length of the Address. “Address” is encoded in UTF8String format and contains the source address that will replace the original source address at the IP header.

The following flags are coded within Octet 5:
a. Bit 5— Ext: If this bit is set to “1”, then one more Address shall be presented to support dual stack IP addresses i.e. one Address Type set 0 and other Address Type set 1, otherwise these fields shall not be present.
b. Bit 6 to 8: Spare, for future use and set to 0.

In this example sequence diagram, it is assumed that the NAT IP address pool is handled in SMF. As mentioned above, SMF has a locally configured NAT IP address pool, which is a pool of IP addresses for (source) NAT purposes. In case the PDU session is:

a. IPv4 session: SMF will select one IPv4 address from the pool and include it in the “Address” field. SMF will set “Address Type” to 0 (IPv4) and set to 0 the Bit 5 in Octet 5.
b. IPv6 session: SMF will select one IPv6 address from the pool and include it in the “Address” field. SMF will set “Address Type” to 1 (IPv6) and set to 0 the Bit 5 in Octet 5.
c. Dual stack (IPv4v6) session: SMF will select two IP addresses from the pool (one IPv4 address and one IPv6 address) and will include them in the corresponding “Address” field, one with “Address Type” to 0 (IPv4) and the other with “Address Type” to 1 (IPv6). SMF will also set to 1 the Bit 5 in Octet 5.

In case the NAT policy indicates to additionally run ALG functionality (see Step 7 above), one of the Spare bits in Octet 5 can be used to indicate UPF to run ALG functionality. As mentioned above, there are some application protocols which include the IP address value in their signaling (e.g. FTP, SIP), and in this case, the UPF needs to support Application Level Gateway (ALG) which modifies those protocols (e.g., by replacing the private IP address with the public one).

It is not shown in the sequence diagram in FIG. 12, but it is also possible that the NAT IP address pool is handled locally in UPF. In this case, the NAT IP address pool will be locally configured at UPF (not at SMF), and the SMF will only need to enable the NAT functionality in UPF. This could be done through a flag (e.g. using the “Network Address Translation” IE by setting the Spare Bit 6 in Octet 5) or through a predefined rule (e.g., by using the “Activate Predefined Rules” IE within “Create/Update PDR” IE in PFCP protocol).

Step 12 of FIG. 12 illustrates: The UPF stores the PDRs/FARs/QERs/URRs and answers back to SMF with a PFCP Session Establishment Response message. Steps 13, 14, 15 and 16 illustrate a situation in which a user starts an application (e.g. YouTube). The UPF detects YouTube application traffic based on the PDR information indicated above. If there is a match, the packet is classified as YouTube and the NAT enforcement action is executed, by replacing the original source IP address (e.g. A.B.C.D) at the IP header by the IP address indicated in the NAT policy (e.g. E.F.G.H).

In case of dual stack PDU sessions (IPv4v6):
a. If the matching packet is an IPv4 packet, the original source IPv4 address will be replaced by the corresponding source IPv4 address, i.e. the one under “Address Type”=0 (IPv4 address).
b. If the matching packet is an IPv6 packet, the original source IPv6 address will be replaced by the corresponding source IPv6 address, i.e. the one under “Address Type” =1 (IPv6 address).

Additionally, in some embodiments, if the NAT policy indicates so, it is also possible to replace the original source port (e.g., port X) at the transport header (e.g., TCP or UDP) by the port indicated in the NAT policy (e.g., port Y).

The example use case in FIG. 12 (and detailed in steps above) allows the support of NAT policies on a per subscriber basis. But the mechanism proposed is general and allows the support of NAT policies with different granularity:
a. On a per global basis (i.e., for any subscriber's PDU session), by installing the FAR including the new Network Address Translation IE for any PDR in any subscriber's PDU session.
b. On a per subscriber basis, by installing the FAR including the new Network Address Translation IE for any PDR in the subscriber's PDU session.
c. Both on a per subscriber and per DNN basis, by installing the FAR including the new Network Address Translation IE for any PDR in the subscriber's PDU session, but only for the DNN of interest. It is proposed the following: In the FAR, there is a parameter (provisioned by the SMF to the UPF) called Network Instance, which is an identifier to an IP domain, a VPN, a transport path, etc. So, SMF will just need to install the FAR including the new Network Address Translation IE only when the Network Instance corresponds to the DNN of interest.
d. Both on a per subscriber and per application basis, by installing the FAR including the new Network Address Translation IE only for a certain PDR (e.g. appld=YouTube) in the subscriber's PDU session.

While the above discussion focuses on a 5G network architecture, the same mechanisms can be applied to 4G. In some embodiments, this could be accomplished by replacing one or more of the following:
a. PCF by PCRF
b. SMF by PGW-C or TDF-C
c. UPF by PGW-U or TDF-U
d. DNN by APN

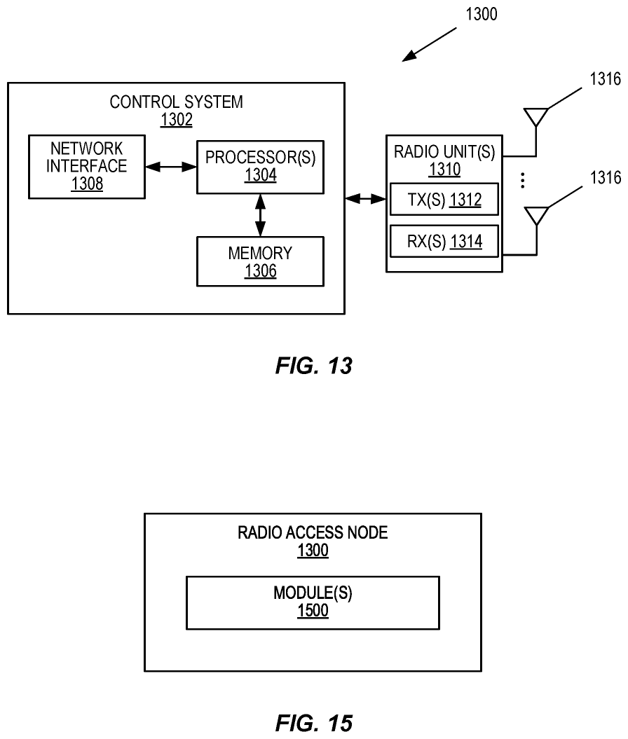

### FIG. 13

FIG. 13 is a schematic block diagram of a radio access node 1300 according to some embodiments of the present disclosure. The radio access node 1300 may be, for example, a base station 102 or 106. As illustrated, the radio access node 1300 includes a control system 1302 that includes one or more processors 1304 (e.g., Central Processing Units (CPUs), Application Specific Integrated Circuits (ASICs), Field Programmable Gate Arrays (FPGAs), and/or the like), memory 1306, and a network interface 1308. The one or more processors 1304 are also referred to herein as processing circuitry. In addition, the radio access node 1300 includes one or more radio units 1310 that each includes one or more transmitters 1312 and one or more receivers 1314 coupled to one or more antennas 1316. The radio units 1310 may be referred to or be part of radio interface circuitry. In some embodiments, the radio unit(s) 1310 is external to the control system 1302 and connected to the control system 1302 via, e.g., a wired connection (e.g., an optical cable). However, in some other embodiments, the radio unit(s) 1310 and potentially the antenna(s) 1316 are integrated together with the control system 1302. The one or more processors 1304 operate to provide one or more functions of a radio access node 1300 as described herein. In some embodiments, the function(s) are implemented in software that is stored, e.g., in the memory 1306 and executed by the one or more processors 1304.

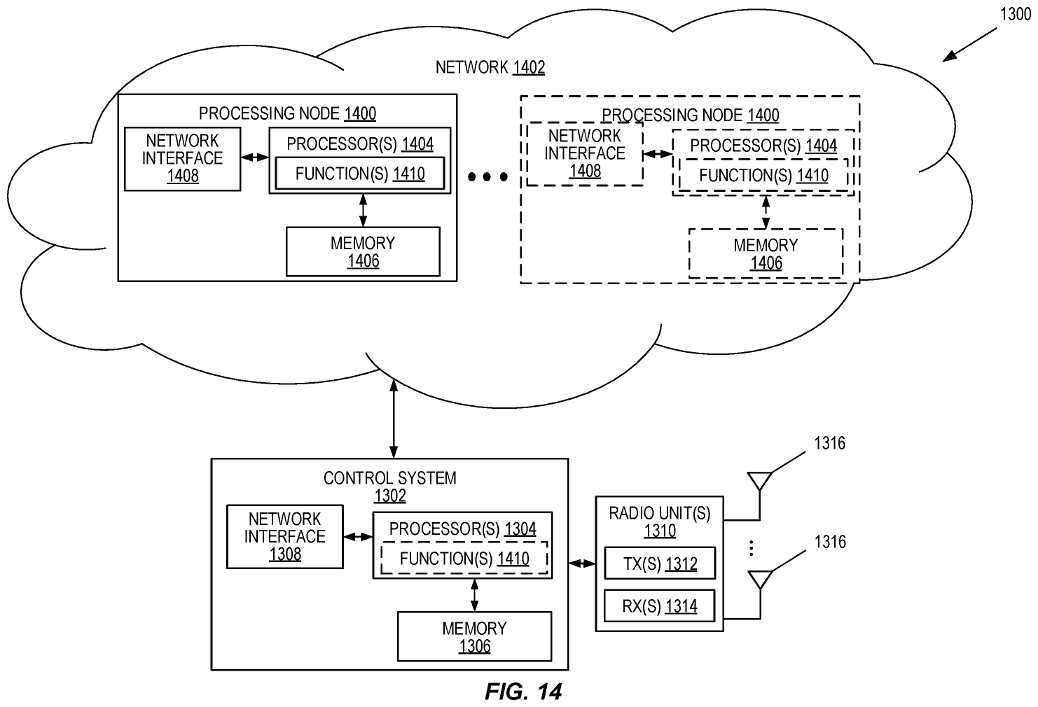

### FIG. 14

FIG. 14 is a schematic block diagram that illustrates a virtualized embodiment of the radio access node 1300 according to some embodiments of the present disclosure. This discussion is equally applicable to other types of network nodes. Further, other types of network nodes may have similar virtualized architectures.

As used herein, a “virtualized” radio access node is an implementation of the radio access node 1300 in which at least a portion of the functionality of the radio access node 1300 is implemented as a virtual component(s) (e.g., via a virtual machine(s) executing on a physical processing node(s) in a network(s)). As illustrated, in this example, the radio access node 1300 includes the control system 1302 that includes the one or more processors 1304 (e.g., CPUs, ASICs, FPGAs, and/or the like), the memory 1306, and the network interface 1308 and the one or more radio units 1310 that each includes the one or more transmitters 1312 and the one or more receivers 1314 coupled to the one or more antennas 1316, as described above. The control system 1302 is connected to the radio unit(s) 1310 via, for example, an optical cable or the like. The control system 1302 is connected to one or more processing nodes 1400 coupled to or included as part of a network(s) 1402 via the network interface 1308. Each processing node 1400 includes one or more processors 1404 (e.g., CPUs, ASICs, FPGAs, and/or the like), memory 1406, and a network interface 1408.

In this example, functions 1410 of the radio access node 1300 described herein are implemented at the one or more processing nodes 1400 or distributed across the control system 1302 and the one or more processing nodes 1400 in any desired manner. In some particular embodiments, some or all of the functions 1410 of the radio access node 1300 described herein are implemented as virtual components executed by one or more virtual machines implemented in a virtual environment(s) hosted by the processing node(s) 1400. As will be appreciated by one of ordinary skill in the art, additional signaling or communication between the processing node(s) 1400 and the control system 1302 is used in order to carry out at least some of the desired functions 1410. Notably, in some embodiments, the control system 1302 may not be included, in which case the radio unit(s) 1310 communicate directly with the processing node(s) 1400 via an appropriate network interface(s).

In some embodiments, a computer program including instructions which, when executed by at least one processor, causes the at least one processor to carry out the functionality of radio access node 1300 or a node (e.g., a processing node 1400) implementing one or more of the functions 1410 of the radio access node 1300 in a virtual environment according to any of the embodiments described herein is provided. In some embodiments, a carrier comprising the aforementioned computer program product is provided. The carrier is one of an electronic signal, an optical signal, a radio signal, or a computer readable storage medium (e.g., a non-transitory computer readable medium such as memory).

### FIG. 15

FIG. 15 is a schematic block diagram of the radio access node 1300 according to some other embodiments of the present disclosure. The radio access node 1300 includes one or more modules 1500, each of which is implemented in software. The module(s) 1500 provide the functionality of the radio access node 1300 described herein. This discussion is equally applicable to the processing node 1400 of FIG. 14 where the modules 1500 may be implemented at one of the processing nodes 1400 or distributed across multiple processing nodes 1400 and/or distributed across the processing node(s) 1400 and the control system 1302.

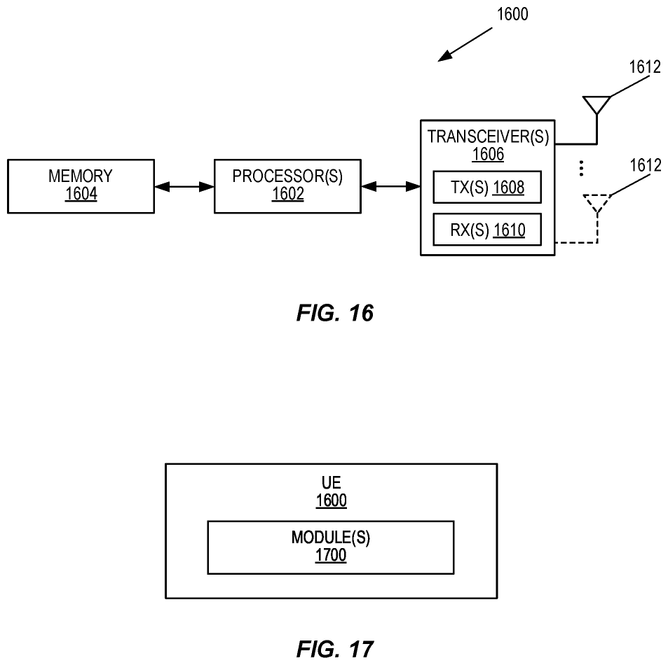

### FIG. 16

FIG. 16 is a schematic block diagram of a UE 1600 according to some embodiments of the present disclosure. As illustrated, the UE 1600 includes one or more processors 1602 (e.g., CPUs, ASICs, FPGAs, and/or the like), memory 1604, and one or more transceivers 1606 each including one or more transmitters 1608 and one or more receivers 1610 coupled to one or more antennas 1612. The transceiver(s) 1606 includes radio-front end circuitry connected to the antenna(s) 1612 that is configured to condition signals communicated between the antenna(s) 1612 and the processor(s) 1602, as will be appreciated by on of ordinary skill in the art. The processors 1602 are also referred to herein as processing circuitry. The transceivers 1606 are also referred to herein as radio circuitry. In some embodiments, the functionality of the UE 1600 described above may be fully or partially implemented in software that is, e.g., stored in the memory 1604 and executed by the processor(s) 1602. Note that the UE 1600 may include additional components not illustrated in FIG. 16 such as, e.g., one or more user interface components (e.g., an input/output interface including a display, buttons, a touch screen, a microphone, a speaker(s), and/or the like and/or any other components for allowing input of information into the UE 1600 and/or allowing output of information from the UE 1600), a power supply (e.g., a battery and associated power circuitry), etc.

In some embodiments, a computer program including instructions which, when executed by at least one processor, causes the at least one processor to carry out the functionality of the UE 1600 according to any of the embodiments described herein is provided. In some embodiments, a carrier comprising the aforementioned computer program product is provided. The carrier is one of an electronic signal, an optical signal, a radio signal, or a computer readable storage medium (e.g., a non-transitory computer readable medium such as memory).

### FIG. 17

FIG. 17 is a schematic block diagram of the UE 1600 according to some other embodiments of the present disclosure. The UE 1600 includes one or more modules 1700, each of which is implemented in software. The module(s) 1700 provide the functionality of the UE 1600 described herein.

Some of the embodiments that have been described above may be summarized in the following itemized manner: 1. A method of operating a Control Plane, CP, entity configured to support Network Address Translation, NAT, the method comprising at least one of:

obtaining NAT information where the NAT information indicates a NAT policy to be applied for User Plane, UP, Internet Protocol, IP, data packets for a wireless device; and

providing the NAT information to a UP entity that is capable of handling UP IP data packets for the wireless device.

2. The method of item 1 wherein obtaining the NAT information further comprises at least one of:

the NAT information is preconfigured in the CP entity; and

obtaining the NAT information from a Policy and Charging entity such as a Policy Control Function, PCF, or a Policy Control Rules Function, PCRF, node or similar.

3. The method of any one of item 1 to 2 wherein the NAT information may be provided in at least one of:

a Policy and Charging Control, PCC, rule; and/or
a Packet Detection Rule, PDR, preferably comprised by a PCC rule; and/or
a Fowarding Action Rule, FAR, preferably comprised by a PDR.

4a. The method of any one of the preceding items wherein:
the NAT information indicates a NAT policy that is based on the subscription information for the wireless device.

4b. The method of any one of the preceding items wherein:

the NAT information and the NAT policy represent corresponding information and may be the same.

4c. The method of any one of the preceding items wherein:

the NAT information may indicate an IP address, e.g. comprised by an “Additional UE IP address IE”, that can be used to identify or match the UP data packets to which the NAT policy shall be applied.

4d. The method of any one of the preceding items wherein:
the NAT information may indicate replacement information, e.g. comprised by an “IP Header Modification IE”, that contains an IPv4/IPv6 address and/or a Port number that can be used to replace the Source/Destination IPv4/IPv6 address respectively and the Source/Destination Port respectively in the UP IP data packets;

4e. The method of any one of the preceding items wherein:

the NAT information may be generated by the Policy and Charging entity such as the PCF or the PCRF based on the subscription information for the wireless device, where the Policy and Charging entity may obtain the subscription information from a repository entity such as a Unified Data Repository, UDR, or a Authentication, Authorization, and Accounting, AAA,/Radius function.

5. The method of any one of the proceeding items further comprising:

obtaining support information for at least one UP entity, which support information indicates that the UP entity supports NAT.

6. The method of item 5 wherein obtaining support information further comprises at least one of: the support information is preconfigured in the CP entity;

obtaining the support information when the CP entity associates with the UP entity;

obtaining the support information from the UP entity; and

obtaining the support information from a repository function entity, e.g. such as a Network Repository Function (NRF) or similar.

7. The method of any one of item 5 to 6 further comprising:

selecting, based on the obtained support information, a UP entity that is capable of handling UP IP data packets for the wireless device.

8. The method of any one of item 1 to 7 wherein the at least one of the UP IP data packets belongs to a given Packet Flow Control Protocol, PFCP, session.

9. The method of any one of item 1 to 8, wherein the NAT information indicates that the NAT policy is to be applied for the UP IP data packets:
on a per global basis (e.g. for all UP IP data packets associated with the wireless device); or
on a per subscriber basis (e.g. as defined by the subscription associated with the wireless device); or
on a per Data Network Name, DNN, basis (e.g. for all UP IP data packets associated with the wireless device and a particular DNN); or
per PDU session basis (e.g. for all UP IP data packets associated with a particular PDU session for the wireless device); or
per data flow basis (e.g. for all UP IP data packets associated with a particular data flow for the wireless device); or
on a per application basis (e.g. for all UP IP data packets associated with the wireless device and a particular application).

10. The method of any one of the above items wherein the CP entity operates in a Fifth Generation Core, 5GC, network.

11. The method of item 10 wherein the CP entity is one or more of: a User Plane Function, UPF; a Session Management Function, SMF; a Policy Control Function, PCF; and a combination of any of these.

12. The method of any one of the above items wherein the CP entity operates in an Evolved Packet Core, EPC, network.

13. The method of item 12 wherein the CP entity is one or more of: a Packet Data Network, PDN, Gateway, PGW, CP function, PGW-C, node; a PGW UP function, PGW-U, node; a Policy Control Rules Function, PCRF, node.

14. A Control Plane, CP, entity configured to support Network Address Translation, NAT, the CP entity comprising at least one processor and memory comprising instructions executable by the at least one processor whereby the function entity is operable to:

obtain NAT information where the NAT information indicates a NAT policy to be applied for User Plane, UP, Internet Protocol, IP, data packets for a wireless device; and

provide the NAT information to a UP entity that is capable of handling UP IP data packets for the wireless device.

15. The CP entity of item 14 wherein being operable to obtain the NAT information further comprises being operable to at least one of:

the NAT information is preconfigured in the CP entity; and

obtain the NAT information from a Policy and Charging entity such as a Policy Control Function, PCF, or a Policy Control Rules Function, PCRF, node.

16. The CP entity of any one of item 14-15 wherein the NAT information may be included in at least one of:

a Policy and Charging Control, PCC, rule;

a Packet Detection Rule, PDR, preferably comprised by a PCC rule; and

a Fowarding Action Rule, FAR, preferably comprised by a PDR.

17a. The CP entity of any one of item 14-16 wherein:

the NAT information indicates a NAT policy that is based on the subscription information for the wireless device.

17b. The CP entity of any one of item 14-17a wherein:

the NAT information and the NAT policy represent corresponding information and may be the same.

17c. The CP entity of any one of item 14-17b wherein:

the NAT information may indicate an IP address, e.g. comprised by an, “Additional UE IP address IE”, that can be used to identify or match the UP data packets to which the NAT policy shall be applied.

17d. The CP entity of any one of item 14-17c wherein:

the NAT information indicates replacement information, e.g. comprised by an “IP Header Modification IE”, that contains an IPv4/IPv6 address and/or a Port number that can be used to replace the Source/Destination IPv4/IPv6 address respectively and the Source/Destination Port respectively in the IP data packets;

17e. The CP entity of any one of item 14-17d wherein:

the NAT information may be generated by the Policy and Charging entity such as the PCF or the PCRF based on the subscription information for the wireless device, where the Policy and Charging entity may obtain the subscription information from a repository entity such as a Unified Data Repository, UDR, or a Authentication, Authorization, and Accounting, AAA,/Radius function.

18. The CP entity of any one of item 14-17e further operable to:

obtain support information for at least one UP entity, which support information indicates that the UP entity supports NAT.

19. The CP entity of item 18 wherein being operable to obtain support information further comprises being operable to at least one of:

the support information is preconfigured in the CP entity; and

obtain the support information when the CP entity associates with the UP entity

obtain the support information from the UP entity; and

obtain the support information from a repository function entity, e.g. such as a Network Repository Function (NRF) or similar.

20. The CP entity of any one of item 14-19 further operable to:

select, based on the obtained support information, a UP entity that is capable of handling UP IP data packets for the wireless device.

21. The CP entity of any one of item 14-20 wherein at least one of the UP IP data packets belongs to a given Packet Flow Control Protocol, PFCP, session.

22. The CP entity of any one of item 14-21 wherein the NAT information indicates that the NAT policy is to be applied for the UP IP data packets:

on a per global basis (e.g. for all UP IP data packets associated with the wireless); or

on a per subscriber basis (e.g. as defined by the subscription associated with the wireless device); or

on a per Data Network Name, DNN, basis (e.g. for all UP IP data packets associated with the wireless device and a particular DNN); or

per PDU session basis (e.g. for all UP IP data packets associated with a particular PDU session for the wireless device); or

per data flow basis (e.g. for all UP IP data packets associated with a particular data flow for the wireless device); or

on a per application basis (e.g. for all UP IP data packets associated with the wireless device and a particular application).

23. The CP entity of any one of item 14-22 wherein the CP entity operates in a Fifth Generation Core, 5GC, network.

24. The CP entity of item 23 wherein the CP entity is one or more of: a User Plane Function, UPF; a Session Management Function, SMF; a Policy Control Function, PCF; and a combination of any of these.

24. The CP entity of any one of item 14-23 wherein the CP entity operates in an Evolved Packet Core, EPC, network.

25. The CP entity of item 24 wherein the CP entity is one or more of: a Packet Data Network, PDN, Gateway, PGW, CP function, PGW-C, node; a PGW UP function, PGW-U, node; a Policy Control Rules Function, PCRF, node.

26. A CP entity configured to support Network Address Translation, NAT, adapted to operate according to the method of any one of item 1 through 13.

27. A CP entity configured to support Network Address Translation, NAT, comprising:

a NAT information obtaining module operable to obtain NAT information where the NAT information indicates a NAT policy to be applied for User Plane, UP, Internet Protocol, IP, data packets for a wireless device; and

a NAT information providing module operable to provide the NAT information to a UP entity that is capable of handling UP IP data packets for the wireless device.

Any appropriate steps, methods, features, functions, or benefits disclosed herein may be performed through one or more functional units or modules of one or more virtual apparatuses. Each virtual apparatus may comprise a number of these functional units. These functional units may be implemented via processing circuitry, which may include one or more microprocessor or microcontrollers, as well as other digital hardware, which may include DSPs, special-purpose digital logic, and the like. The processing circuitry may be configured to execute program code stored in memory, which may include one or several types of memory such as ROM, RAM, cache memory, flash memory devices, optical storage devices, etc. Program code stored in memory includes program instructions for executing one or more telecommunications and/or data communications protocols as well as instructions for carrying out one or more of the techniques described herein. In some implementations, the processing circuitry may be used to cause the respective functional unit to perform corresponding functions according one or more embodiments of the present disclosure.

While processes in the figures may show a particular order of operations performed by certain embodiments of the present disclosure, it should be understood that such order is exemplary (e.g., alternative embodiments may perform the operations in a different order, combine certain operations, overlap certain operations, etc.).

At least some of the following abbreviations may be used in this disclosure. If there is an inconsistency between abbreviations, preference should be given to how it is used above. If listed multiple times below, the first listing should be preferred over any subsequent listing(s).
3GPP Third Generation Partnership Project
5G Fifth Generation
5GC Fifth Generation Core
5GS Fifth Generation System
MA Authentication, Authorization, and Accounting
AF Application Function
AMF Authentication Management Function
AN Access Network
APN Access Point Name
AS Application Server
ATSSS Access Steering Switching Splitting
AUSF Authentication Server Function
CP Control Plane
CUPS Control User Plane Separation
DL Downlink
DNN Data Network Name
eNB Enhanced or Evolved Node B
EPC Evolved Packet Core
EPG Evolved Packet Gateway
EPS Evolved Packet System
FAR Forwarding Action Rule
FTP File Transfer Protocol
gNB New Radio Base Station
HSS Home Subscriber Service
IE Information Element
IP Internet Protocol
LTE Long Term Evolution
MME Mobility Management Entity
MPTCP Multi Path Transport Control Protocol
MTC Machine Type Communication
NAPT Network Address and Port Translation
NAT Network Address Translation
NEF Network Exposure Function
NF Network Function
NR Next Generation Radio/New Radio
NRF Network Function Repository Function
NSSF Network Slice Selection Function
OTT Over-the-Top
PCC Policy and Charging Control
PCEF Policy and Charging Enforcement Function
PCF Policy Control Function
PCRF Policy Control Rules Function
PDI Packet Detection Information
PDN Packet Data Network
PDR Packet Detection Rule
PDU Protocol Data Unit
PFCP Packet Flow Control Protocol
P-GW Packet Data Network Gateway
PGW-C PDN Gateway Control Plane Function
PGW-U PDN Gateway User Plane Function
QoS Quality of Service
RAN Radio Access Network
RAT Radio Access Technology
SCEF Service Capability Exposure Function
SIP Session Initiation Protocol
SMF Session Management Function
UDM Unified Data Management
UDR Unified Data Repository
UE User Equipment
UP User Plane
UPF User Plane Function
URR Usage Reporting Rule
VPN Virtual Private Network

Those skilled in the art will recognize improvements and modifications to the embodiments of the present disclosure. All such improvements and modifications are considered within the scope of the concepts disclosed herein.

1. A method of operating a Control Plane, CP, entity configured to support Network Address Translation, NAT, the method comprising at least one of:
obtaining NAT information where the NAT information indicates a NAT policy to be applied for User Plane, UP, Internet Protocol, IP, data packets for a wireless device; and
providing the NAT information to a UP entity that is capable of handling UP IP data packets for the wireless device.

2. The method of claim 1 wherein obtaining the NAT information further comprises at least one of:
the NAT information is preconfigured in the CP entity; and
obtaining the NAT information from a Policy and Charging, PCF, entity or a Policy Control Rules Function, PCRF, node.

3. The method of claim 1 wherein the NAT information is provided in at least one of:
a Policy and Charging Control, PCC, rule;
a Packet Detection Rule, PDR; and
a Fowarding Action Rule, FAR.

4. The method of claim 1 wherein the NAT information:
the NAT information indicates a NAT policy that is based on the subscription information for the wireless device; and/or
the NAT information and the NAT policy represent the same or corresponding information; and/or
the NAT information indicates an IP address that can be used to identify or match the UP data packets to which the NAT policy shall be applied; and/or
the NAT information indicates replacement information that contains an IPv4/IPv6 address and/or a Port number that can be used to replace the Source/Destination IPv4/IPv6 address respectively and the Source/Destination Port respectively in the UP IP data packets; and/or
the NAT information is generated by the Policy and Charging entity based on the subscription information for the wireless device, where the Policy and Charging entity obtains the subscription information from a repository entity, or a Authentication, Authorization, and Accounting, AAA,/Radius function.

5. The method of claim 1 further comprising:
obtaining support information for at least one UP entity, which support information indicates that the UP entity supports NAT.

6. The method of claim 5 wherein obtaining support information further comprises at least one of:
the support information is preconfigured in the CP entity;
obtaining the support information when the CP entity associates with the UP entity;
obtaining the support information from the UP entity; and
obtaining the support information from a repository function entity.

7. The method of claim 5 further comprising:
selecting, based on the obtained support information, a UP entity that is capable of handling UP IP data packets for the wireless device.

8. The method of claim 1 wherein the at least one of the UP IP data packets belongs to a given Packet Flow Control Protocol, PFCP, session.

9. The method of claim 1, wherein the NAT information indicates that the NAT policy is to be applied for the UP IP data packets:
on a per global basis; or
on a per subscriber basis; or
on a per Data Network Name, DNN, basis; or
per PDU session basis; or
per data flow basis; or
on a per application basis.

10. A Control Plane, CP, entity configured to support Network Address Translation, NAT, the CP entity comprising at least one processor and memory comprising instructions executable by the at least one processor whereby the function entity is operable to:
obtain NAT information where the NAT information indicates a NAT policy to be applied for User Plane, UP, Internet Protocol, IP, data packets for a wireless device; and
provide the NAT information to a UP entity that is capable of handling UP IP data packets for the wireless device.

11. The CP entity of claim 10 wherein being operable to obtain the NAT information further comprises being operable to at least one of:
the NAT information is preconfigured in the CP entity; and
obtain the NAT information from a Policy and Charging, PCF, entity or a Policy Control Rules Function, PCRF, node.

12. The CP entity of claim 10 wherein the NAT information is provided in at least one of:
a Policy and Charging Control, PCC, rule;
a Packet Detection Rule, PDR; and
a Fowarding Action Rule, FAR.

13. The CP entity of claim 10 wherein:
the NAT information indicates a NAT policy that is based on the subscription information for the wireless device; and/or
the NAT information and the NAT policy represent the same or corresponding information; and/or
the NAT information indicates an IP address that can be used to identify or match the UP data packets to which the NAT policy shall be applied; and/or
the NAT information indicates replacement information that contains an IPv4/IPv6 address and/or a Port number that can be used to replace the Source/Destination IPv4/IPv6 address respectively and the Source/Destination Port respectively in the UP IP data packets; and/or
the NAT information is generated by the Policy and Charging entity based on the subscription information for the wireless device, where the Policy and Charging entity obtains the subscription information from a repository entity (UDR), or a Authentication, Authorization, and Accounting, AAA,/Radius function.

14. The CP entity of claim 10 further operable to:
obtain support information for at least one UP entity, which support information indicates that the UP entity supports NAT.

15. The CP entity of claim 10 wherein being operable to obtain support information further comprises being operable to at least one of:
the support information is preconfigured in the CP entity;
obtain the support information when the CP entity associates with the UP entity;
obtain the support information from the UP entity; and
obtain the support information from a repository function entity.

16. The CP entity of claim 10 further operable to:
select, based on the obtained support information, a UP entity that is capable of handling UP IP data packets for the wireless device.

17. The CP entity of claim 10 wherein at least one of the UP IP data packets belongs to a given Packet Flow Control Protocol, PFCP, session.

18. The CP entity of claim 10 wherein the NAT information indicates that the NAT policy is to be applied for the UP IP data packets:
on a per global basis; or
on a per subscriber basis; or
on a per Data Network Name, DNN, basis; or
per PDU session basis; or
per data flow basis; or
on a per application basis.
